(19) United States
(12) Patent Application Publication
(10) Pub. No.: US 2025/0352926 A1
(43) Pub. Date: Nov. 20, 2025

(54) WATER SEALED TANK

(71) Applicant: JOHN COCKERILL HYDROGEN BELGIUM, SERAING (BE)

(72) Inventors: Liu ZILONG, Suzhou Jiangsu (CN); Zhao XIAOLIANG, Suzhou Jiangsu (CN); Li PING, Suzhou Jiangsu (CN)

(73) Assignee: JOHN COCKERILL HYDROGEN BELGIUM, SERAING (BE)

(21) Appl. No.: 19/130,433

(22) PCT Filed: Dec. 1, 2023
(86) PCT No.: PCT/EP2023/084019

§ 371 Date: May 15, 2025

(30) Foreign Application Priority Data
Dec. 2, 2022 (CN) 202223236556.X

(51) Int. Cl. B01D 19/00; B01D 5/00

(52) U.S. Cl. CPC B01D 19/0063; B01D 5/0006; B01D 19/0068

(57) ABSTRACT

A water sealed tank include a tank body and a heat conducting pipe. The tank body includes a gas-liquid inlet, a water outlet, and a gas outlet. The gas outlet is close to or located on a top portion of the tank body and communicates with the tank body. The water outlet is close to or located on a bottom portion of the tank body. The gas-liquid inlet communicates with the tank body and is used for feeding a gas-water mixture into the tank body, and a gas separated from the gas-water mixture inside the tank body is discharged from the gas outlet. At least a part of the heat conducting pipe is located inside the tank body, and used for a liquid to flow through, to allow the heat conducting pipe to exchange heat with water inside the tank body and heat the water inside the tank body.

### TECHNICAL FIELD

The invention relates to the technical field of water sealing, in particular to a water sealed tank.

### BACKGROUND ART

A water sealed tank is an important component of a drainage system in a water electrolytic hydrogen The principle of the water sealed production apparatus. tank is that hydrogen is separated from water by a water column pressure, and air is blocked from m entering a hydrogen production system, so that the risk of a mixed explosion of hydrogen and air is reduced. The water sealed tank plays an important role in the safety of the drainage system.

Water sealed tanks are generally mounted inside or outside a hydrogen production station. A water sealed tank mounted inside or outside an ordinary hydrogen production station is prone to freezing in winter in northern regions due to the ambient temperature, and freezing of the water sealed tank causes the drainage system to malfunction, hydrogen cannot be effectively separated from water, and the water electrolytic apparatus has to stop working. Generally adopted anti-freezing measures include adding an anti-freezing liquid into the water sealed tank and adding an insulation and heating device to an outer cylinder of the water sealed tank. However, the disadvantage of adding the anti-freezing liquid into the water sealed tank is that the concentration of the anti-freezing liquid gradually decreases with the increase of the discharge amount, and the anti-freezing effect will be lost. If the anti-freezing liquid is not regularly inspected and supplemented, there is also a risk of freezing.

Accordingly, there remains a need for a water sealed tank to address the above problems.

### SUMMARY

The invention provides a water sealed tank to solve the above problems.

The objective of the invention is achieved by the following technical solution:
a water sealed tank, comprising: a tank body and a heat conducting pipe.

The tank body comprises a gas-liquid inlet, a water outlet and a gas outlet, wherein the gas outlet is close to or located on a top portion of the tank body and communicates with the tank body, the water outlet is close to or located on a bottom portion of the tank body, the gas-liquid inlet communicates with the tank body and is used for feeding a gas-water mixture into the tank body, and a gas separated from the gas-water mixture inside the tank body is discharged from the gas outlet.

At least a part of the heat conducting pipe is located inside the tank body, and used for a liquid to flow through, so as to allow the heat conducting pipe to exchange heat with water inside the tank body and heat the water inside the tank body.

Preferably, the tank body has a through hole, the heat conducting pipe is a blind pipe with an opening, an outer wall of the blind pipe is sealingly connected to the tank body through the through hole, the opening of the blind pipe is provided for the liquid to flow in, and the other end of the blind pipe opposite the opening extends into the water inside the tank body.

Preferably, the tank body has two through holes, the heat conducting pipe has two openings, the two openings of the heat conducting pipe respectively sealingly pass through one of the through holes, one opening of the heat conducting pipe is used for liquid inflow, and the other opening of the heat conducting pipe is used for liquid outflow.

Preferably, the heat conducting pipe comprises a helix section between the two openings, the helix section being immersed in the water inside the tank body.

Preferably, the heat conducting pipe comprises a spiral section between the two openings, the spiral section being immersed in the water inside the tank body.

Preferably, the water sealed tank further comprises a guide member and a float ball, the guide member has a lumen for guiding the float ball to rise and fall and communicating with the tank body, a bottom portion of the lumen corresponds to the water outlet, the float ball follows the rise and fall of a liquid surface inside the tank body, and when the liquid surface falls and the float ball is brought close to the water outlet, the float ball serves to close the water outlet under the guidance of the lumen, and a part of the heat conducting pipe is sleeved outside the guide member.

Preferably, a bottom portion of the float ball is also connected to an extension rod and a plunger, the plunger being connected below the float ball via the extension rod and being used for closing the water outlet.

Preferably, a limiting member is also provided inside the tank body, the limiting member being used for the extension rod to pass through and guiding the movement of the extension rod.

Preferably, the tank body further comprises a water replenishment port close to or located at the top portion of the tank body;
the liquid inside the heat conducting pipe is an electrolyte solution discharged from the electrolysis of water to produce hydrogen, and the gas-water mixture is a mixture of hydrogen and water; and
the water outlet of the tank body is connected to an overflow pipe, and the height of an outlet of the overflow pipe is located between the top portion and the bottom portion of the tank body.

Preferably, the water sealed tank further comprises a temperature sensor, an electric valve and a controller, wherein the temperature sensor is connected inside the tank body for obtaining a water temperature inside the tank body, the electric valve is connected in the heat conducting pipe for opening or closing the heat conducting pipe, and the controller is electrically connected to the temperature sensor and the electric valve.

Compared with the prior art, the beneficial effects of the invention at least include:
a water electrolysis process for preparing hydrogen generates a lot of additional heat, and by using the heat generated by electrolysis to heat the water inside the water sealed tank, the heat is effectively utilized without adding additional heating facilities in the water sealed tank to increase the water temperature, thereby reducing the waste of energy.

The invention also concerns a water electrolytic hydrogen production apparatus comprising said water sealed tank.

### BRIEF DESCRIPTION OF THE DRAWINGS

FIG. 1 is a cross-section schematic structure diagram of a water sealed tank according to an embodiment of the invention;

FIG. 2 is a partial enlarged view of a portion A in FIG. 1;

FIG. 3 is a schematic structure diagram of a heat conducting pipe according to an embodiment of the invention;

FIG. 4 is a schematic structure diagram of a heat conducting pipe according to another embodiment of the invention; and

FIG. 5 is a schematic structure diagram of a heat conducting pipe according to yet another embodiment of the invention.

In the figures: 1. tank body; 11. through hole; 12. guide member; 13. float ball; 14. extension rod; 15. plunger; 2. gas-liquid inlet; 3. water replenishment port; 4. water outlet; 5. gas outlet; 51. overflow pipe; 6. heat conducting pipe.

### DETAILED DESCRIPTION OF EMBODIMENTS

Example embodiments will now be described more fully with reference to the accompanying drawings. However, the example embodiments can be implemented in various forms and should not be construed as limited to the embodiments set forth herein; rather, these embodiments are provided to make the invention more comprehensive and complete, and to fully convey the concepts of the example embodiments to those skilled in the art. The same reference numerals indicate the same or similar structure in the figures, and therefore repeated descriptions of the structure will be omitted.

The words expressing positions and directions described in the present application are described by way of example with reference to the accompanying drawings, but changes may be made as required, and all changes are included within the scope of protection of the invention.

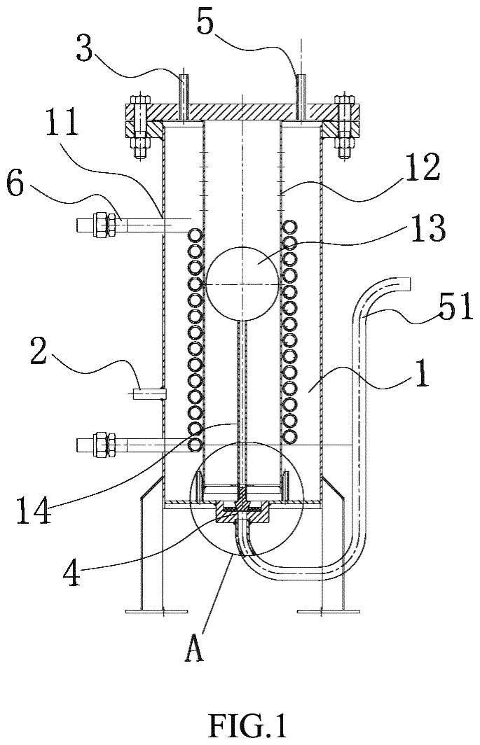

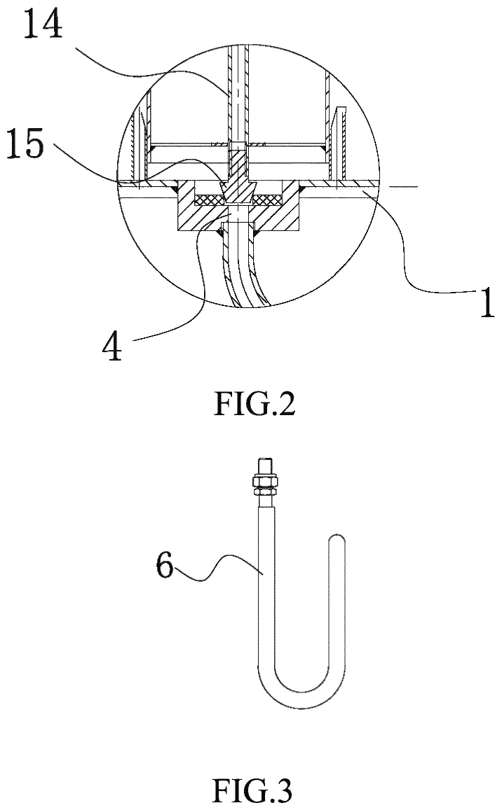

Referring to FIGS. 1 to 5, the invention provides a water sealed tank, comprising: a tank body 1 and a heat conducting pipe 6.

The tank body 1 comprises a gas-liquid inlet 2, a water outlet 4 and a gas outlet 5, wherein the gas outlet 5 is close to or located on a top portion of the tank body 1 and communicates with the tank body 1, the water outlet 4 is close to or located on a bottom portion of the tank body 1, the gas-liquid inlet 2 communicates with the tank body 1 and is used for feeding a gas-water mixture into the tank body 1, and a gas separated from the gas-water mixture inside the tank body 1 is discharged from the gas outlet 5. At least a part of the heat conducting pipe 6 is located inside the tank body 1, and used for a liquid to flow through, so as to allow the heat conducting pipe 6 to exchange heat with water inside the tank body 1 and heat the water inside the tank body 1. In the process of preparing hydrogen by electrolysis of water, the gas-liquid inlet 2 is connected to a gas outlet 5 for discharging hydrogen in an electrolytic cell. During the electrolysis process, a small amount of water vapor is contained in the hydrogen, and the hydrogen and the water vapor enter the tank body 1 via the gas-liquid inlet 2. When the fed gas-water mixture is a mixture of hydrogen and a small amount of water vapor, the water vapor is adsorbed by the water inside the water sealed tank and then removed, and the separated hydrogen is floated to the gas outlet 5 at the top portion, discharged via the gas outlet 5 and collected by other devices.

An electrolyte solution in the electrolytic cell generates a large amount of heat when participating in an electrolytic reaction, so that the temperature of the electrolyte solution is relatively high. Some of the electrolyte solution enters the tank body 1 via the heat conducting pipe 6, and the electrolyte solution heats the pipe body of the heat conducting pipe 6, and then the heat conducting pipe 6 transfers the heat to the water located inside the tank body 1, thereby increasing the water temperature of the water and preventing the water inside the tank body 1 from freezing due to a low temperature.

Referring to FIG. 3, the tank body 1 has a through hole 11, and the heat conducting pipe 6 is a blind pipe with an opening. An outer wall of the blind pipe is sealingly connected to the tank body 1 through the through hole 11, the opening of the blind pipe is provided for the liquid to flow in, and the other end of the blind pipe opposite the opening extends into the water inside the tank body 1. In the process of manufacturing the tank body 1, for example, a through hole 11 is drilled on a side wall of the tank body 1, a part of the heat conducting pipe 6 extends into the tank body 1, and then a gap between an outer wall of the heat conducting pipe 6 and the through hole 11 is connected together by welding, so that the water inside the tank body 1 is prevented from being lost due to poor sealability. Before operation, an appropriate amount electrolyte of solution may be manually injected into the blind pipe to prevent the occurrence of air inside the blind pipe. The temperature of the electrolyte solution in the electrolytic cell is transferred to the electrolyte solution inside the blind pipe through the liquid, and then heat is transferred to the water inside the tank body 1 through a pipe wall of the blind pipe to prevent the water inside the tank body 1 from freezing in a low temperature environment below zero degrees, and then affecting the normal operation of a hydrogen production system.

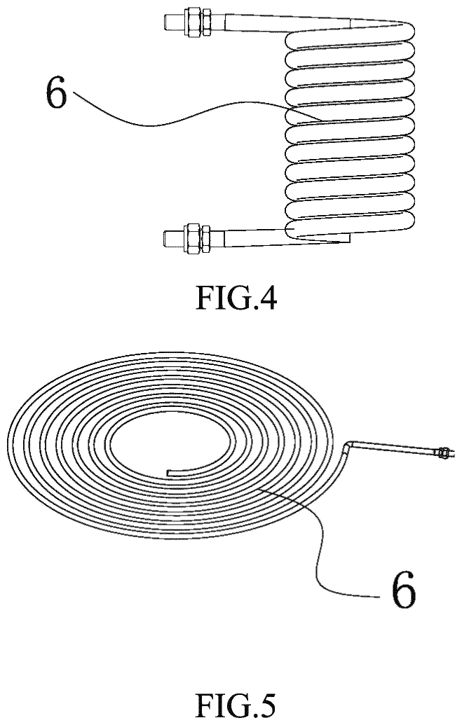

Referring to FIGS. 1 and 4, the tank body 1 has two through holes 11, and the heat conducting pipe 6 has two openings. The two openings of the heat conducting pipe 6 respectively sealingly pass through one of the through holes 11, one opening of the heat conducting pipe 6 is used for liquid inflow, and the other opening of the heat conducting pipe 6 is used for liquid outflow. The positions of the two through holes 11 on the tank body 1 are not limited herein. The electrolyte solution in the heat conducting pipe 6 communicates with the electrolytic cell through the two openings, and the electrolyte solution in the heat conducting pipe 6 having the two openings may flow in the heat conducting pipe 6, thereby increasing the heat transfer efficiency. In addition, a small-sized driving pump may be added at one end of the heat conducting pipe 6 to circulate the electrolyte solution in the electrolytic cell through the heat conducting pipe 6 under the action of the driving pump so as to transfer heat to the water inside the tank body 1, thereby efficiently raising the temperature of the water and preventing freezing.

Further, it is also possible that a temperature sensor is provided inside the tank body 1, an electric valve is connected inside the heat conducting pipe 6, and a controller is provided outside the tank body 1. The temperature sensor is connected inside the tank body 1 for obtaining a water temperature inside the tank body 1, the electric valve is connected in the heat conducting pipe 6, and the controller is used to receive an input signal from the temperature sensor and control the electric valve to open or close the heat conducting pipe 6. When the water temperature inside the tank body 1 is near the freezing point, the temperature sensor sends an electric signal to the controller, and after the electric signal is processed by the controller, a control command is transmitted to the electric valve to control the electric valve to open. After the electric valve is opened, the electrolyte solution in the electrolytic cell enters the tank body 1 via the heat conducting pipe 6, and heat is then transferred to the water inside the tank body 1 through the heat conducting pipe 6 to prevent the water inside the tank body 1 from freezing. When the water temperature inside the tank body 1 is high for a long time, the controller may control the electric valve to close, so that the electrolyte solution fully participates in the reaction of electrolytic hydrogen production in the electrolytic cell.

For example, in FIG. 4, the heat conducting pipe 6 comprises a helix section between the two openings, the helix section being immersed in the water inside the tank body 1. The helix section is, for example, an equidistant helix. The equidistant helix heat conducting pipe 6 has a large contact area between the heat conducting pipe 6 and the water inside the tank body 1 during heat conduction or heat exchange, so that the heat-conducting effect is good, and the water at different depths inside the tank body 1 can be simultaneously heated.

For example, in FIG. 5, the heat conducting pipe 6 comprises a spiral section between the two openings, the spiral section being immersed in the water inside the tank body 1. The spiral section is, for example, a disk-shaped spiral. The disk-shaped spiral heat conducting pipe 6 is located at the same depth of water level inside the tank body 1, and the heat conducting range is relatively concentrated. At the same time, the water temperature at a certain depth inside the tank body 1 can be rapidly raised.

In an embodiment, the water sealed tank further comprises a guide member 12 and a float ball 13. The guide member 12 has a lumen for guiding the float ball 13 to rise and fall and communicating with the tank body 1, and a bottom portion of the lumen corresponds to the water outlet 4. The float ball 13 follows the rise and fall of a liquid surface inside the tank body 1, and when the liquid surface falls and the float ball 13 is brought close to the water outlet 4, the float ball 13 serves to close the water outlet 4 under the guidance of the lumen. A part of the heat conducting pipe 6 is sleeved outside the guide member 12. When hydrogen is collected, the gas enters the tank body 1, and the water level inside the tank body 1 is initially in a full state. When the gas enters the tank body 1, a small amount of water is discharged from the water outlet 4, and then the electrolytic hydrogen evenly passes through the tank body 1 and is output from the gas outlet 5. When the output rate of the hydrogen is high, the amount of water discharged from the tank body 1 increases, providing sufficient space for the stable output of the hydrogen. At this time, the float ball 13 falls with the water level inside the tank body 1 and blocks the water outlet 4 under the guidance of the guide member 12 to ensure a certain amount of water inside the tank body 1, and prevent the hydrogen and the air from directly contacting and then causing an explosion.

In a further embodiment, a bottom portion of the float ball 13 is also connected to an extension rod 14 and a plunger 15, the plunger 15 being connected below the float ball 13 via the extension rod 14 and being used for closing the water outlet 4. The bottom portion of the float ball 13 is additionally provided with the extension rod 14. The extension rod 14 is connected to the bottom portion of the float ball 13, for example, by means of bonding, and the plunger 15 is connected to a lower end of the extension rod 14. The length of the extension rod 14 determines the lowest water level inside the tank body 1. When the water level inside the tank body 1 falls, the float ball 13 drives the extension rod 14 to move down synchronously until the plunger 15 is inserted into the water outlet 4, preventing the water inside the tank body 1 from continuing to fall. When the rate of hydrogen passing through the tank body 1 decreases, tap water is replenished into the tank body 1 via a water replenishment port 3.

Further, a limiting member is also provided inside the tank body 1, and the limiting member is used for the extension rod 14 to pass through and guiding the movement of the extension rod 14. For example, the limit is connected inside the guide member 12, such as a shaft sleeve. An inner hole of the shaft sleeve passes through a lower end of the limiting member, and when the float ball 13 drives the limiting member to move, the limiting member does not swing left and right along with water flow, playing a role in assisting the alignment and insertion of the limiting member into the water outlet 4.

In an embodiment, the tank body 1 further comprises a water replenishment port 3 close to or located at the top portion of the tank body 1. The liquid inside the heat conducting pipe 6 is an electrolyte solution discharged from the electrolysis of water to produce hydrogen, and the gas-water mixture is a mixture of hydrogen and water. The water outlet 4 of the tank body 1 is connected to an overflow pipe 51, and the height of an outlet of the overflow pipe 51 is located between the top portion and the bottom portion of the tank body 1. The overflow pipe 51 communicates with the tank body 1, so that the height of the outlet of the overflow pipe 51 determines the lowest water level inside the tank body 1. The water level inside the tank body 1 is prevented from being too low, resulting in sufficient separation of the hydrogen and the water, and affecting the quality of hydrogen preparation. When the water level inside the tank body 1 is too low, an external water supply pipe feeds water into the tank body 1 via the water replenishment port 3.

Although embodiments of the invention have been shown and described above, it is to be understood that the above-described embodiments are exemplary and are not to be construed as limiting the invention. Those of ordinary skill in the art, without departing from the principles and purposes of the invention, may make changes, modifications, substitutions and variations to the above-described embodiments. All of these changes are intended to be within the scope of protection of the invention.

1. A water sealed tank, comprising:
a tank body, the tank body comprising a gas-liquid inlet, a water outlet and a gas outlet, wherein the gas outlet is close to or located on a top portion of the tank body and communicates with the tank body, the water outlet is close to or located on a bottom portion of the tank body, the gas-liquid inlet communicates with the tank body and is used for feeding a gas-water mixture into the tank body, and a gas separated from the gas-water mixture inside the tank body is discharged from the gas outlet; and
a heat conducting pipe, at least a part of the heat conducting pipe being located inside the tank body, and used for a liquid to flow through, so as to allow the heat conducting pipe to exchange heat with water inside the tank body and heat the water inside the tank body.

2. The water sealed tank according to claim 1, wherein the tank body has a through hole, the heat conducting pipe is a blind pipe with an opening, an outer wall of the blind pipe is sealingly connected to the tank body through the through hole, the opening of the blind pipe is provided for the liquid to flow in, and the other end of the blind pipe opposite the opening extends into the water inside the tank body.

3. The water sealed tank according to claim 1, wherein the tank body has two through holes, the heat conducting pipe has two openings, the two openings of the heat conducting pipe respectively sealingly pass through one of the through holes, one opening of the heat conducting pipe is used for liquid inflow, and the other opening of the heat conducting pipe is used for liquid outflow.

4. The water sealed tank according to claim 3, wherein the heat conducting pipe comprises a helix section between the two openings, the helix section being immersed in the water inside the tank body.

5. The water sealed tank according to claim 3, wherein the heat conducting pipe comprises a spiral section between the two openings, the spiral section being immersed in the water inside the tank body.

6. The water sealed tank according to claim 1, wherein the water sealed tank further comprises a guide member and a float ball, the guide member has a lumen for guiding the float ball to rise and fall and communicating with the tank body, a bottom portion of the lumen corresponds to the water outlet, the float ball follows the rise and fall of a liquid surface inside the tank body, and when the liquid surface falls and the float ball is brought close to the water outlet, the float ball serves to close the water outlet under the guidance of the lumen, and a part of the heat conducting pipe is sleeved outside the guide member.

7. The water sealed tank according to claim 6, wherein a bottom portion of the float ball is also connected to an extension rod and a plunger, the plunger being connected below the float ball via the extension rod and being used for closing the water outlet.

8. The water sealed tank according to claim 7, wherein a limiting member is also provided inside the tank body, the limiting member being used for the extension rod to pass through and guiding the movement of the extension rod.

9. The water sealed tank according to claim 1, wherein the tank body further comprises a water replenishment port close to or located at the top portion of the tank body;
the liquid inside the heat conducting pipe is an electrolyte solution discharged from the electrolysis of water to produce hydrogen, and the gas-water mixture is a mixture of hydrogen and water; and
the water outlet of the tank body is connected to an overflow pipe, and the height of an outlet of the overflow pipe is located between the top portion and the bottom portion of the tank body.

10. The water sealed tank according to claim 1, wherein the water sealed tank further comprises a temperature sensor, an electric valve and a controller, the temperature sensor is connected inside the tank body for obtaining a water temperature inside the tank body, the electric valve is connected in the heat conducting pipe for opening or closing the heat conducting pipe, and the controller is electrically connected to the temperature sensor and the electric valve.

11. A water electrolytic hydrogen production apparatus, comprising a water sealed tank according to claim 1.
